(19) United States
(12) Patent Application Publication
(10) Pub. No.: US 2006/0197756 A1
(43) Pub. Date: Sep. 7, 2006

(54) Multi-mode optical pointer for interactive display system

(75) Inventor: Brian Y. Sun, Garland, TX (US)

Correspondence Address: DENNIS T. GRIGGS, 17950 PRESTON ROAD, SUITE 1000, DALLAS, TX, 75252, US

(73) Assignee: Keytec, Inc., Richardson, TX (US)

(21) Appl. No.: 11/372,480

(22) Filed: Mar. 9, 2006

Related U.S. Application Data
(63) Continuation-in-part of application No. 10/852,303, filed on May 24, 2004.

(51) Int. Cl. G09G 5/00

(52) U.S. Cl. 345/179

(57) ABSTRACT

Control of a presentation computer is accomplished by a wireless optical pointer that projects an encoded control cursor onto a projection screen in an interactive presentation system. The optical pointer is selectively operable in a position-dependent, control cursor spot projection mode by actuation of a first push button switch that enables remote initiation of various computer keyboard commands and/or pointing device (mouse, touch pad, track ball) position-dependent cursor operations, e.g., select, move, left click, right click and double click. Operation of the pointer in a presentation function selection mode is initiated by actuation of a second push button switch in which a predetermined spatial image pattern can be projected onto the screen by gesturing, thereby enabling remote annotating or highlighting an object on the display screen. Optionally, operation of the pointer in the presentation function selection mode can be initiated by stylus actuation of a control switch which allows the presenter, while standing in close proximity or within reach of a presentation screen, to underline a word, highlight an object, circle an object, strike out a word or object, insert a note next to a word or object, or annotate an object or word with a check mark. These actions are performed by manually drawing a stylus across the area of the presentation screen that is to be annotated, marked or highlighted.

### CROSS-REFERENCE TO RELATED APPLICATION

This application is a continuation-in-part of commonly owned, co-pending U.S. application Ser. No. 10/852,303 entitled “Visual input pointing device for interactive display system,” filed on May 24, 2004, in the name of Brian Y. Sun and Jung Yu Chen, which is incorporated herein by reference for all purposes.

### BACKGROUND OF THE INVENTION

1. Field of the Invention

The present invention is related to wireless pointing devices for use with interactive optical image projection and display systems, and in particular to a laser diode optical pointing device that is selectively operable in a position-dependent, control cursor spot projection mode, and in a presentation function mode for gesturing an image, annotating or highlighting an object on a display screen.

2. Description of the Related Art

Interactive image projection and display systems use technologies including ultrasonic, infrared and radio frequency (RF) technologies to provide increased user mobility relative to the computer processor and/or display screen. These technologies typically employ a wireless transmitter and receiver to communicate control and status information between the operator and the computer. Display systems have been developed for remotely initiating various computer keyboard commands and/or pointing device (mouse, touch pad, track ball) position-dependent cursor operations, e.g., select, move, left click, right click and double click.

Conventional display systems use sensors positioned on the operator or on the computer, and/or on a display screen to detect movement of the user and/or a wireless pointing device relative to the sensors. While generally acceptable for some applications, these techniques may impose proximity or distance limitations. Likewise, these systems require complex and often expensive equipment that may not be readily adaptable to different facilities and may not meet the specific needs of large as well as small viewing audiences.

Portable laptop and notebook computers are now being used for controlling the optical projection of graphical presentations, slide show presentations and computer generated images and/or demonstrations. Large interactive screens are used for displaying text and various graphical images in business meeting rooms and in classrooms that are intended for viewing by large audiences. The projected images are generated electronically by a display computer, such as a personal computer (PC) or a laptop computer, by execution of presentation-generating software, such as Microsoft PowerPoint®. In such display systems, the portable computer provides video outputs such as standard VGA, Super VGA, or XGA.

Many presentations, such as slide shows, require relatively simple control of the computer during presentation. Commands that advance or reverse slides or initiate a display sequence require only a basic user interface or remote control to communicate with the computer. However, more sophisticated presentations, for example, computer generated web images containing browser-searchable on-line content, require a complex remote controller interface to effectively operate the computer and position the cursor on the presentation screen for browser control. At the display computer, either the presenter or an assistant controls the projected image by means of key strokes or pointing device (mouse, touch pad, track ball) manipulations to produce cursor operations that position a cursor in the appropriate area of the computer monitor display screen, thus exercising control over content selection.

The presenter may be standing at a lectern, or may be moving about near the screen or toward the audience. Thus the presenter will have limited direct control over the image being displayed when using a conventional projection display system. A conventional system requires the operator to return to the display computer, or to have an assistant seated at the computer, to provide control for the presentation. At the display computer, either the presenter or the assistant controls the displayed image by means of keystrokes or by “mouse commands” with a cursor in the appropriate area of the computer monitor display screen.

The actions of the operator moving to the display computer, or communicating with the assistant, detract from a natural progression and flow of the presentation. Generally, it is desirable that the presenter be able to interactively control the display presentation or modify the image appearing on the projection screen without repeatedly redirecting his attention, thus retaining a high degree of rapport and eye contact with the audience.

Conventional laser pointers project a laser spot onto a region of browser presentation images. Such systems typically require multiple steps or actions to be taken in exercising control over the presentation. In one arrangement, the presenter calls up a drop-down menu for selection of a particular function, such as select, annotate, page up, and the like. In another arrangement, a mouse double-click command is produced in which the presenter must first activate, then deactivate, then activate again, and again deactivate the laser pointer while maintaining the projected laser spot within an imaginary rectangular area of the presentation image.

Mouse commands such as select, move, left click, right click and double click and other presentation functions, such as advancing to a subsequent image, zooming in, underlining, annotating or highlighting, are produced and executed in other conventional interactive systems by “gesturing” with a laser pointer to produce predetermined spatial patterns on the screen. The spatial patterns are acquired and interpreted by a control system which subsequently issues display commands to a projector. Such systems require a set of pre-established gesture spatial patterns for each display command stored in a memory look-up table, along with pattern recognition circuitry. The use of such gesture systems require operator training on how to reproduce the spatial patterns by gesturing, and is limited somewhat by how well the user can learn the gesturing technique in order to reproduce recognizable spatial patterns.

According to commonly assigned and co-pending U.S. application Ser. No. 10/852,303 entitled “Visual input pointing device for interactive display system,” a laser pointing device is equipped with two or more push button switches that allow the presenter to manually select operation in a position-dependent, control cursor spot projection mode, or in a presentation function mode for manually “gesturing” an image, or highlighting an object on a display screen.

Many times during an interactive presentation with a dual-mode laser pointer, the presenter may find it desirable to execute the control gesture at close range to the screen. For example, while standing in close proximity or within reach of the screen, the presenter may desire to underline a word, highlight an object, circle an object, strike out a word or object, annotate an object or word with a check mark, or insert a note next to a word or object. For such operations, it would be convenient and expedient for the operator to perform the gesture without changing his position and without redirecting his attention, thus retaining a high degree of rapport and eye contact with the audience. However, some presenters find it awkward and difficult to gesture a recognizable spatial pattern in close proximity to the screen, and sometimes must step away from the screen to achieve a recognizable pattern.

Accordingly, there is a continuing interest in providing a system for remotely controlling the computer of an interactive image projection display system that will simplify command and control, while providing reliable execution of remote commands while using an optical pointer in close proximity to the screen, especially in connection with the presentation function mode for manually underlining a word, highlighting an object, circling an object, striking out a word or object, annotating an object or word with a check mark, or inserting a note next to a word or object on a display screen, while giving the presenter improved mobility, thus allowing the presenter to focus his attention on the presentation and his audience, and minimizing the actions needed to exercise control over mode selection and use of the pointer.

### BRIEF SUMMARY OF THE INVENTION

The present invention provides an improved wireless optical pointer for projecting encoded optical control cursor signals onto the presentation screen of an interactive optical projection system for remotely controlling a computer having an associated computer-controlled image projector. The optical pointer is selectively operable by push button switches in a position-dependent, control cursor spot projection mode, and in a presentation function mode for manually “gesturing” a predetermined spatial pattern for initiating a presentation function such as highlighting or annotating an object on a display screen. The optical control cursor signals are characterized by one or more primary attributes, for example image intensity or image repetition (blink) rate, that are independent of the attributes of projected background images and objects. The control cursor signals may also be characterized by one or more secondary attributes, for example pixel area (image size), color, or pattern (image shape), that correspond with specific computer commands. Preferably, the image properties of the primary attributes and secondary attributes are mutually exclusive with respect to each other, respectively, thus allowing cursor-related processing operations in the position-dependent, control cursor spot projection mode and in the presentation function (annotation) mode to be performed independently.

In the preferred embodiment, the optical pointer is provided with a first mode selection push button switch that is finger actuated, a second mode selection push button switch that is finger actuated, and a third mode selection switch with stylus actuator that is actuated to the closed circuit condition by manually engaging the stylus against the display screen.

Actuation of the first mode selection push button switch enables pointer operation in the position-dependent, control cursor spot projection mode in which the optical control cursor signal is characterized by one or more primary attributes, for example image intensity. Selection of this mode allows remote initiation of various computer keyboard commands and/or pointing device (mouse, touch pad, track ball) position-dependent cursor operations, e.g., select, move, left click, right click and double click.

Actuation of the second mode selection push button switch enables pointer operation in the presentation function mode in which the optical control cursor signal is characterized by one or more primary attributes, for example blink rate. Selection of the second mode allows remote “gesturing” a recognizable spatial pattern that initiates a presentation function such as highlighting an object on a display screen, as well as remote initiation of presentation functions such as advancing to a subsequent image, zooming in, underlining, annotating or highlighting, are produced by “gesturing” with a laser pointer to produce predetermined spatial patterns on the screen.

Actuation of the third mode selection push button switch by engagement of the stylus enables pointer operation in the presentation function mode in which the optical control cursor signal is characterized by one or more primary attributes, for example blink rate. Selection of the third mode allows the presenter, while standing in close proximity or within reach of the screen, to underline a word, highlight an object, circle an object, strike out a word or object, annotate an object or word with a check mark, or insert a note next to a word or object.

Images projected onto the presentation screen are scanned and sensed by a remote video camera. The video images are scanned frame by frame and the image of the encoded control cursor is detected by the image processor and decoded by routines executed under the control of recognition software in the image processor.

Recognition techniques are used for detection and differentiation of the control cursor relative to other projected images on the display screen. After detection of the control cursor with reference to a primary attribute, one or more of the secondary attributes, if any, are decoded and used alone or in combination to generate a corresponding command or commands to control the computer. These commands may be used to emulate control of the computer typically provided by a conventional peripheral I/O control device such as a mouse, track ball, or keyboard.

Moreover, the present invention provides a relatively simple remote user interface that enables conventional keyboard and pointing device commands to be input to the computer, comparable to operation of a mouse, track ball or keyboard. The present invention permits a user to control a computer for a screen display presentation from any location where the display presentation screen is accessible via an optical pointer and can be monitored by a remote video camera. The multiple mode selection feature of the pointer permits the pointer to be operated effectively either remotely or in close proximity to the display screen as desired in the cursor position dependent operating mode and in the presentation function gesturing mode, and optionally in the presentation function annotation mode when the presenter is in close proximity (within arm's reach) of the display screen, without requiring gesturing.

### BRIEF DESCRIPTION OF THE SEVERAL VIEWS OF THE DRAWING

The accompanying drawing is incorporated into and forms a part of the specification to illustrate the preferred embodiments of the present invention. Various advantages and features of the invention will be understood from the following detailed description taken with reference to the attached drawing figures in which:

FIG. 1 is a system block diagram showing an interactive computer presentation system with an optical beam pointer and video scanning for remotely controlling a presentation computer according to the present invention;

FIG. 2 is a perspective view of the optical beam pointer shown in FIG. 1;

FIG. 3 is a front elevationl view of the optical beam pointer of FIG. 2;

FIG. 4 is an exploded, partially assembled perspective view of the optical beam pointer of FIG. 2;

FIG. 5 is a perspective view, partially broken away, showing the laser head and switch stylus of the optical beam pointer of FIG. 2;

FIG. 6 is a perspective view of the optical beam pointer of FIG. 2 being used in the close proximity scribe mode for manually annotating the display screen with an optical image; and

FIG. 7 is a simplified circuit block diagram of the optical beam pointer of the present invention.

### DETAILED DESCRIPTION OF THE INVENTION

Preferred embodiments of the invention will now be described with reference to various examples of how the invention can best be made and used. Like reference numerals are used throughout the description and several views of the drawing to indicate like or corresponding parts.

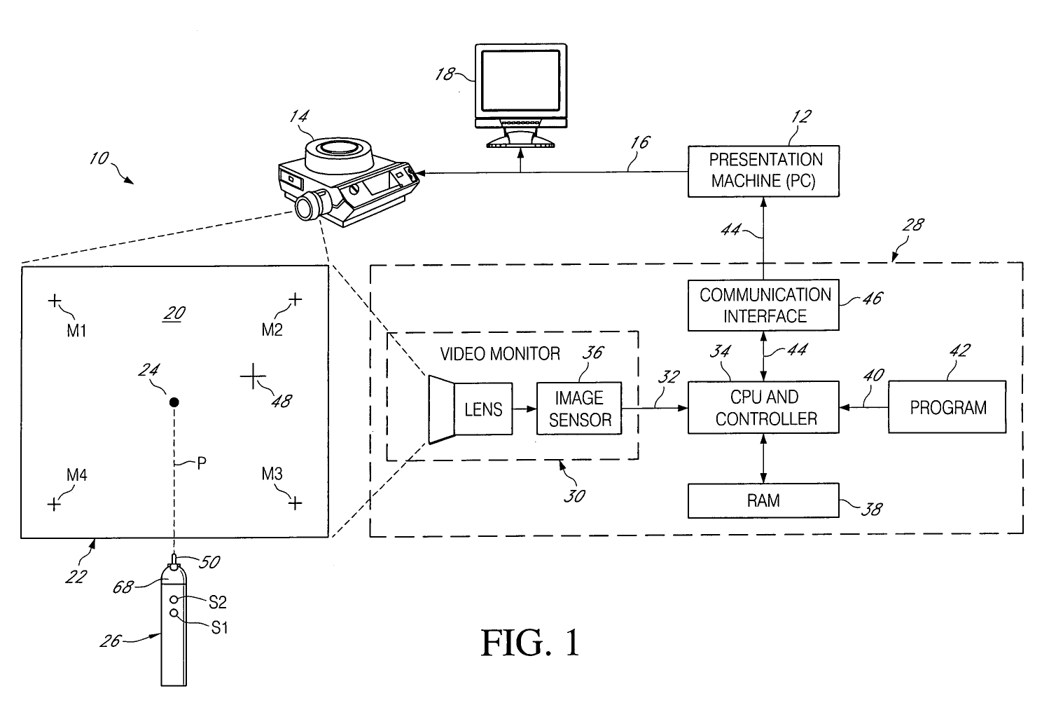

Referring now to FIG. 1, an interactive computer presentation system 10 with optical tracking for remotely controlling computer and projector operations is shown. The remote control capability includes control over various application programs, for example a browser and/or the operating system of a presentation computer 12, as well as the operation of an optical video projector 14. The presentation computer 12 generates a video output signal 16 derived from a local or remote program source (e.g., a browser, modem link or compact disk) that is output to a local display monitor 18, for example a flat screen LCD display of a lap top or notebook computer, and also output to the video projector 14. The video projector 14 projects visible video images 20 corresponding to the computer generated video signal output 16 onto a projection surface or display screen, indicated generally by reference numeral 22.

Preferably, the display screen 22 is a conventional passive presentation screen, remotely located from the presentation computer 12 and of a light color to provide sufficient contrast relative to the projected image of computer output generated by the video projector 14. Various surfaces may be used to provide a passive projection surface, including fine textured slide show display screens, painted walls, and the like.

Other presentation display systems can be used to good advantage in the practice of the present invention including active display devices, for example, a television CRT monitor, a liquid crystal display (LCD) screen of a laptop or notebook computer, plasma display screens, electrolumenescent display screens and optical projection display screens (front and rear).

Referring again to FIG. 1, an encoded control cursor 24 is superimposed on the projected video program image 20 which is output from the presentation computer 12. The control cursor 24 is generated externally relative to the presentation computer 12, i.e., generated by some other device which could include another computer, an optical image projector, or the like. In the preferred embodiment, the control cursor 24 is generated by a hand-held optical pointer 26 that is capable of projecting a control cursor having one or more primary attributes and one or more secondary attributes, and capable of varying at least one of the secondary attributes.

The primary attributes of the control cursor 24 are independent of projection and monitoring angle limitations as well as presentation background image limitations. In the preferred embodiment, the primary image attributes that satisfy these criteria are cursor image intensity and image repetition rate (blink rate), either of which may be used for control cursor detection. The secondary attributes of the control cursor 24 may be identical or similar to the attributes of the projected background images. Preferably, the secondary attributes of the control cursor that can be encoded and varied to correspond with predetermined commands include color, size and a predetermined pattern, shape or geometrical profile.

In the preferred embodiment, the optical pointer 26 produces a control cursor 24 that has a significantly higher image intensity than the projected screen image 20 and is therefore easily differentiated from computer generated images, objects and other program material appearing on the presentation screen 22. This feature is provided by a beam projector circuit 27 that producing a continuous laser beam having a predetermined image intensity that is relatively greater than the expected peak value of the image intensity of the presentation background images. Moreover, the optical pointer 26 is operable to vary one of the secondary attributes, for example the color, shape, size or illumination pattern of the control cursor 24, to generate one or more commands to remotely control the browser and/or the operating system of the presentation computer 12.

Referring now to FIG. 1 an image processor 28 receives video input from a video monitor camera 30 focused on the presentation screen 22. The video monitor camera outputs a streaming video signal 32 to a microprocessor 34. The video monitor camera 30 includes an image sensor 36 that scans an image including at least a substantial portion of the projected image 20 appearing on the presentation screen 22, and generates a digital image that is output as the streaming video signal 32. Optionally, where an active presentation screen is utilized, the video monitor camera 30 scans at least a substantial portion of the active presentation screen, e.g., a computer monitor, lap top LCD display, or television CRT monitor.

The image processor 28 analyzes the scanned image frame by frame to identify the frame containing the control cursor image 24 as uniquely identified by one or more of its embedded primary attributes, captures the frame image and stores it in RAM memory 38 for analysis, and determines the coordinate location of the control cursor. The image processor then determines (decodes) at least one secondary attribute of the control cursor 24 as directed by instructions 40 fetched from conventional analytical and recognition software operating programs stored in a memory module 42.

The position coordinates of the control cursor 24 and the decoded command data are output as a serial data stream 44 from the microprocessor 34 via a communications interface 46 to the presentation computer 12. The communications interface may be implemented by any conventional means, e.g., wireless (infra-red, R.F. or acoustic wave) or by signal conductor (universal serial bus, RS232 or PS/2 port) communication links. The presentation computer 12 receives the serial data 44 and generates an appropriate command or commands to move an internal computer generated cursor 48 to approximately the same position as the control cursor 24.

After the control image with its embedded primary attribute has been detected and the position of the control cursor has been determined, the image processor 28 processes the captured image of the control cursor 24 to decode one or more of the secondary attributes to generate position-dependent command signals that are used to remotely control the presentation computer 12. Such position or context-dependent commands may emulate commands such as “left-click” or “right-click” generated by a traditional computer peripheral I/O device, such as a mouse, track ball, touch pad, or the like. Likewise, various other commands including command signals for operating the video projector 14 may be associated with one or more secondary attributes of the control cursor 24.

The presentation computer 12 periodically generates calibration marks M1, M2, M3 and M4 to calibrate or register the image captured by the video monitor camera 16 relative to the presentation image 22 that is projected on the presentation screen 22. Preferably, the presentation image also contains computer generated boundary marks that are used to delineate the active tracking region where scanning for the control cursor 24 is performed.

The calibration or registration process may be repeated automatically at predetermined intervals, based on a user request, and/or when the control cursor 24 is not detected. Preferably, the tracking boundary marks are moved inwardly from the calibration corners toward the center of the screen to simplify detection of the control cursor and subsequent analysis and decoding of its secondary attributes. In this embodiment, only the area delineated by calibration marks is searched or scanned to detect the frame containing the control cursor 24. If a frame containing the control cursor is not detected within the area defined by boundary marks, the boundary marks are progressively moved toward the original calibration corners of the processed image until the control cursor 24 is detected.

The video frames are repeatedly captured and processed to detect a frame containing an image characterized by at least one primary attribute of the control cursor 24. Typical frame capture rates are thirty or sixty frames per second. The frame capture rate of the video camera 30 and/or the output of an active screen or projector are selected to minimize aliasing and other interference within the frequency bands of interest. Any such interference effects may also be reduced by appropriate filtering of the captured image.

Determination of the locations of the display field boundary corners and the attributes of the control cursor is simplified because their identifying characteristics are known. Identification and analysis of the control cursor 24 within the captured frame image may be accomplished using any number of known image processing techniques. For example the pixel intensity differential method may be used to find calibration marks that indicate the corner boundaries of the display field. Also, the intensity differential method may be used to detect and confirm the presence of the control cursor primary attributes of image intensity and image repetition (blink) rate for initial detection and control cursor location purposes.

Conventional analytical and recognition software may be used to detect and recognize the various secondary attributes of the control cursor 24, e.g., color, image size, shape and pattern. The present invention is independent of the particular image processing techniques utilized to identify or detect the primary and secondary attributes of the control cursor. An exemplary method for determining position and attribute information of the control cursor is provided below.

The locations of image corners and the control cursor 24 are determined according to conventional video quadrant analysis. Once the calibration or registration process has determined the corner coordinates, at least one primary attribute of the control cursor 24 is monitored or tracked by repeatedly capturing and analyzing frames. Preferably, the position of the control cursor 24 is determined by reference to one or more of the known primary attributes of the control cursor. The secondary attributes of the control cursor 24, such as shape, color, size and pattern, are conditionally analyzed and decoded only after one or more of the primary control cursor attributes has been detected and confirmed within a captured frame.

The primary and secondary attributes embedded in the control cursor are detected and decoded by routines executed by the analytical and recognition software 42 in the image processor 28. The primary image attribute, image intensity, is preset in the optical projector to a relatively high level relative to the expected value of the peak image intensity of the presentation background images. The primary image attribute, cursor repetition (blink) rate, is also preset at a predetermined repetition rate. In these embodiments, the optical pointer is a monochromatic optical pointer, for example an optical diode laser pointer, equipped with a control circuit for emitting a continuous laser beam at a predetermined image intensity, and optionally, at a predetermined image intensity and predetermined repetition rate.

The secondary attribute of shape, geometrical profile or pattern of an encoded control cursor 24 is produced by projecting a polychromatic optical beam through a special aperture formed in a user-selectable, for example a rotary carousel or template contained in the optical pointer 26. Likewise the secondary attribute of cursor image color is varied by projecting an optical beam of polychromatic light through a selected color filter of an array of color filters carried on the rotary carousel. The filtered light beam is focused on the presentation screen by an adjustable lens.

Preferred cursor image patterns are represented by regular geometrical shapes, for example as indicated by the circular or spot profile 24 (FIG. 1), corresponding with the command “click and move cursor”; a diamond profile, corresponding with the command “right click”; a rectangular profile, corresponding with the command “double click”; a pyramid profile, corresponding with the command “scroll up”; an inverted pyramid profile, corresponding with the command “scroll down”; a triangular profile, corresponding with the command “scroll left”; and an inverted triangular profile corresponding with the command “scroll right.”

After completing the calibration or registration process, images are repeatedly captured and processed. A captured image is then processed to detect at least one primary attribute of the control cursor. Preferably, the primary attributes are image intensity and image repetition rate. The position of the control cursor, is preferably also detected relative to the position of the calibration marks. If the processor fails to detect at least one of the primary attributes, the processor is reset and the processing steps are repeated until a frame containing the control cursor with one or more embedded primary attributes is captured and confirmed.

Upon detection of a frame containing a projected control cursor the primary attributes are identified and confirmed, the cursor position coordinates are calculated, and this information is captured (stored) in the memory module 38. Then, the image processor 28 is conditionally advanced to the next processing step where the captured image then processed to detect at least one secondary attribute of the control cursor. Preferably, the secondary attributes are image size, image color, and image pattern.

In addition, any one or more of the primary attributes may be used in combination with any one of the secondary attributes to generate appropriate commands for the presentation computer. For example, the primary attribute, repetition (blink) rate, may be used in combination with the various secondary attributes, namely size, color, or pattern, of the control cursor, i.e., different command can be provided by selecting either the color and/or shape of the control cursor in combination with its blink rate or beam intensity.

The secondary attributes of the control cursor that are detected and decoded are converted to corresponding commands to control the presentation computer 12. This may be accomplished by any of a number of known strategies. For example, a data structure may be used to associate various secondary attributes or combinations of primary attributes and secondary attributes with corresponding commands in a particular software application.

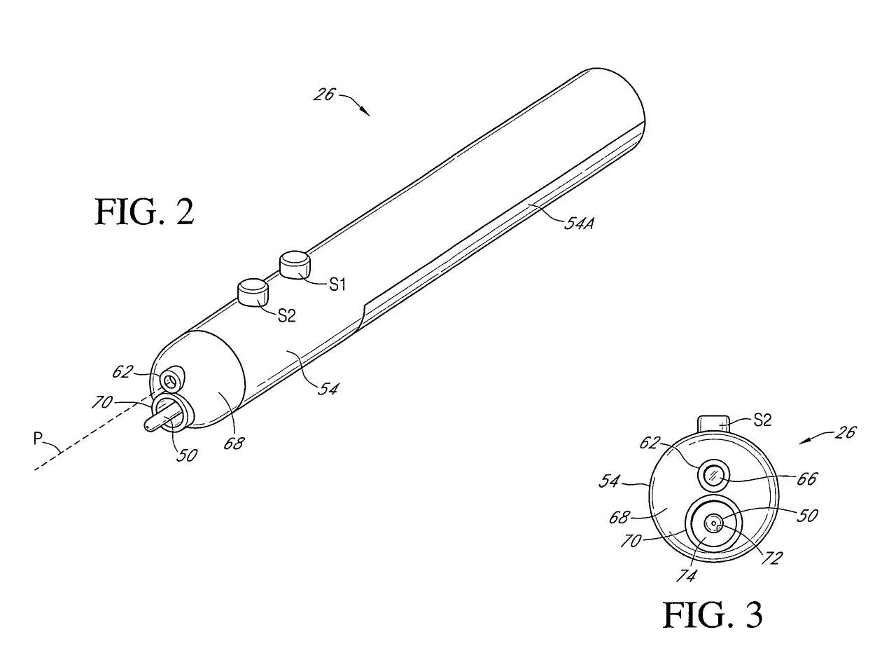

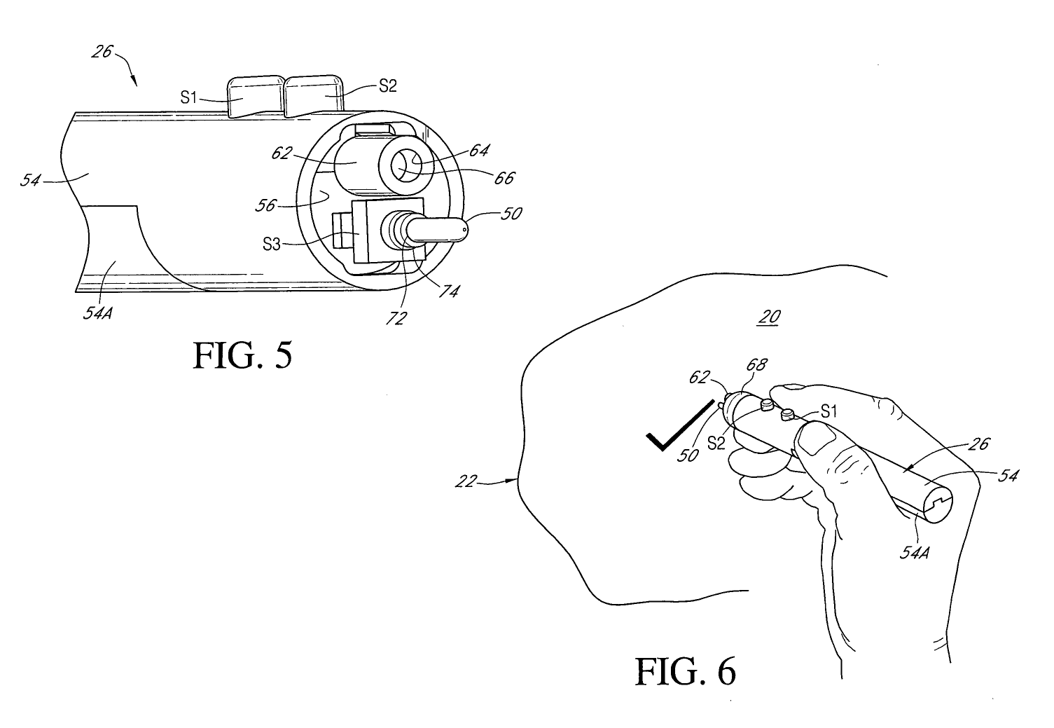

Referring now to FIG. 2-FIG. 5, the optical pointer 26 is provided with a first mode selection push button switch S1 that is finger actuated, a second mode selection push button switch S2 that is finger actuated, and a third mode selection switch S3 that is coupled to a stylus actuator 50. The stylus 50 actuates the switch S3 to the closed circuit operating mode or condition when the stylus is manually engaged or pushed against the presentation screen 22. The switches S1, S2 and S3 are conventional single pole, single throw, momentary contact switches that are spring biased to the open circuit (OFF) operating mode or condition in the absence of a depressing force. These push button switches are conventional two-position momentary ON devices actuated with a push button that is ON when pressed and OFF when released. These switches have an internal spring mechanism returning the push button to its “out” or “unpressed” (OFF) position, for momentary closed circuit contact (ON) operation.

The switches S1, S2 and S3 are mounted inside of a tubular casing 54 in which other laser pointer components are also enclosed. These components include a laser diode module 56, a circuit board 58, a laser diode driver circuit module 60, and a DC voltage power supply formed by a set of dry cell batteries B1, B2.

The laser diode module 56 includes a firing lens assembly 62 having a laser firing aperture 64 on the front end thereof, a lens 66 and an O-ring seal (not shown). These components are covered by a removable end cap 68.

The tubular housing 54 is made of injection molded, durable polymer resin to hold the battery set B1, B2 and laser pointer components. A removable housing member 54A is detachable to provide access to the inside of the housing for installing and replacing the battery set. The housing 54 includes internal pockets for receiving switch S1, switch S2, switch S3, the circuit board 58 and the laser driver module 60. The battery set B1, B2 is formed by two conventional dry cell batteries, for example size (AA) 1.5 VDC, connected in series, with the series positive pole being connected upon actuation of S1, S2 or S3 to the +Vcc input of the laser driver circuit module 60.

The push button switch S3 comprises an insulated switch housing 70 through which the stylus 50 projects. The stylus 50 includes a first end portion 50A disposed inside the housing 54 and mechanically coupled to the to switched contactor element of switch S3, and a second end portion 50B projecting out of the housing. The stylus 50 is guided through a smooth bore aperture 72 of an inset collar portion 74. The bore aperture 72 is radially offset from the laser projection axis P, and the longitudinal axis of the stylus extends in parallel with the laser projection axis. The stylus 50 is made of a durable polymer resin material, for example nylon, and is coupled by mechanical linkage L to the switched contactor element of the push button switch S3. A bias spring (not shown) yieldably holds the switched contactor element of push button switch S3 in the open circuit (switch S3 OFF) condition in the absence of a depressing force.

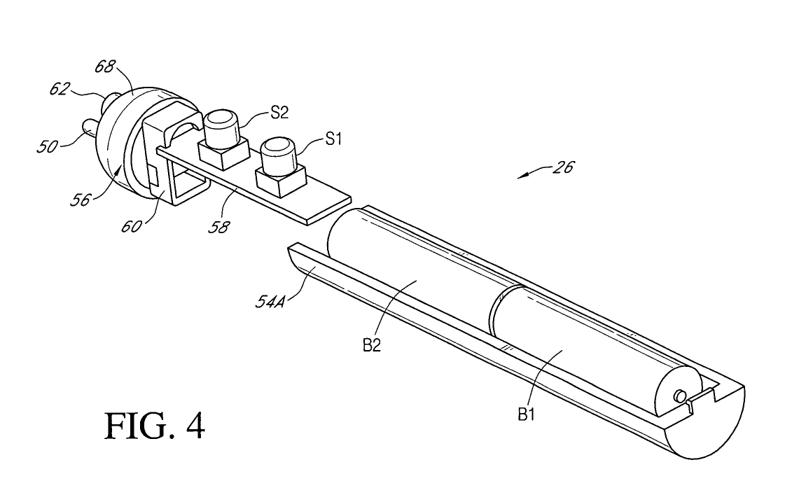

Referring to FIG. 3 and FIG. 4, the laser module 56 is fitted into the tubular housing and makes electrical contact against output terminals LDA, MDA, LDK and AGND of the laser driver circuit module 60. The battery set B1, B2 is inserted into the tubular housing 54 with its series connected negative pole making electrical contact against a conductive interconnect 82 that connects to the negative (GND) input of the laser driver circuit 60. Likewise, its series connected positive pole makes electrical contact against a conductive interconnect 84 that connects voltage and current flow from the series connected battery set to the positive +Vcc input of the laser driver circuit 60 when any one of the switches S1, S2 or S3 are actuated.

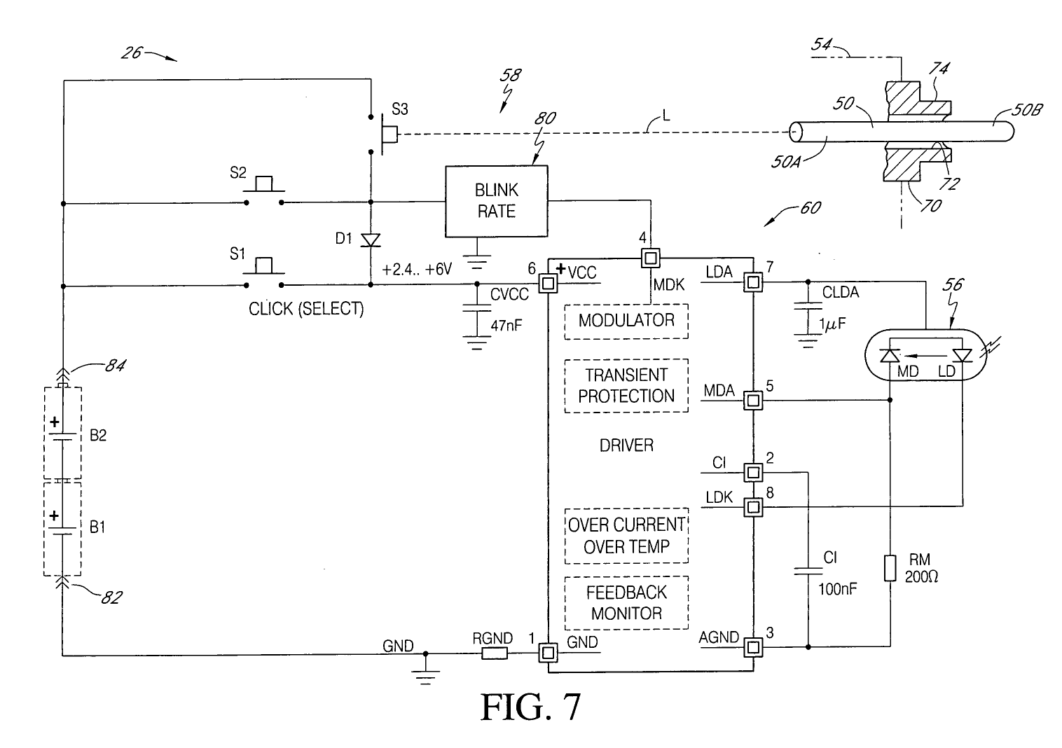

The simplified circuit diagram of FIG. 7 shows the interconnection of the battery set B1, B2, push button switches S1, S2 and S3, laser driver 60, modulator signal generator circuit 80, and laser head 56. A steering diode D1 allows independent operation of push button switch S1 relative to the operation of switches S2 an S3. Basically, the laser driver 60 circuit is a conventional constant current control circuit that is operable from a supply voltage in the range of +2.6 to +6 VDC. A feedback monitoring circuit stabilizes electric current to the laser light generator, laser diode LD. A photoelectric monitor diode MD receives the laser beam for feedback reference.

The driver circuit 60 includes protection against transients, over current and excessive temperature conditions. The driver also provides a soft start which regulates the diode power dissipation when the driver is first switched on. A modulation signal from the external modulation signal generator circuit 80 is applied to the auxiliary input MDK which causes the driver to operate the laser diode LD in a pulse repetition output mode, from DC to a few kHz. A suitable laser diode driver 60 can be obtained from several commercial sources, for example, Part No. IC-WK (2.4V CW Laser Diode Driver) sold by IC-Haus Corporation USA of Napierville, Ill.

The push button switches S1, S2, the modulation signal generator 80, the steering diode D1, and the power wiring conductors are mounted on the circuit board 58. The battery socket interconnects 82, 84 are mounted on the removable housing member 54A. The control switch S3 is mounted on the laser head 56 in actuating alignment with the stylus 50. The power wiring conductors electrically interconnect the power supply B1, B2 to the switches S1, S2 and S3 for closing an electrical power conducting circuit between the power supply and the laser driver module 60 in a power ON mode, and for opening an electrical power conducting circuit between the power supply and the laser driver module in a power OFF mode.

The mode selection switches S1, S2 and S3 can be operated independently of each other for selectively operating the optical pointer 26 in a position-dependent, control cursor spot projection mode (S1), or in a presentation function mode (S2) for remotely “gesturing” a control function image on the screen, or in a close proximity scribe mode (S3) in which annotating or highlighting an object on the screen is performed by pressing the stylus against the screen when the presenter is in close proximity to the display screen.

Upon closure of push button switch S1, an operating voltage of +3 VDC is applied to the laser driver circuit, and the laser diode LD in the laser head 56 is triggered to produce a continuous laser beam that is transmitted through the lens 66 at a predetermined beam intensity. Actuation of the first mode selection push button switch S1 enables pointer operation in the position-dependent, control cursor spot projection mode in which the optical control cursor signal is characterized by one or more primary attributes, for example image intensity. Selection of this mode by actuation of push button switch S1 allows remote initiation of various computer keyboard commands and/or pointing device (mouse, touch pad, track ball) position-dependent cursor operations, e.g., select, move, left click, right click and double click.

Upon closure of push button switch S2, an operating voltage of approximately +3 VDC (less the small voltage drop across the steering diode D1) is applied to the laser driver circuit 60 and to the modulation signal circuit 80. The modulation circuit produces a modulation signal that is input to the modulation input MDK of the laser driver circuit 60. The semiconductor laser diode LD in the laser head 56 is triggered to produce a pulsed laser beam that is transmitted through the lens 66 at a predetermined beam intensity and blink rate (pulse repetition rate). Actuation of the second mode selection push button switch S2 thus enables pointer operation in the presentation function mode which allows remote “gesturing” or highlighting an object on the display screen 22, as well as remote initiation of presentation functions such as advancing to a subsequent image, zooming in, underlining, annotating or highlighting.

Upon closure of the control switch S3, an operating voltage of approximately +3 VDC (less the small voltage drop across the steering diode D1) is applied to the laser driver circuit 60 and to the modulation signal circuit 80. Actuation of the third mode selection control switch S3 by pressure engagement of the stylus 50 against the display screen 22 enables pointer operation in the presentation function mode in which the optical control cursor signal is characterized by one or more primary attributes, for example blink rate.

Actuation of the control switch S3 allows the presenter, while standing in close proximity or within reach of the screen 22, to underline a word, highlight an object, circle an object, strike out a word or object, insert a note next to a word or object, or annotate an object or word with a check mark 52, for example as shown in FIG. 6. These actions are performed by engaging the stylus against the screen 22 and manually drawing the stylus 50 across the area of the screen that is to be annotated, marked or highlighted. The pressure engagement of the stylus 50 against the screen closes the control switch S3, causing the output of the laser diode LD to be modulated, either in intensity or blink rate (pulse repetition), thus invoking the presentation function mode without gesturing.

The words used in this specification are words of description rather than limitation, and it is understood that various changes may be made without departing from the spirit and scope of the invention as defined by the appended claims.

I claim:

1. An optical pointer for projecting a laser beam onto a presentation screen of an optical projection system, the optical pointer comprising:
a housing;
an electrical power supply disposed in the housing;
a laser module disposed in the housing, the laser module including a laser light generator for projecting a beam of laser light along an axis;
a control switch electrically coupled to the power supply and to the laser module for closing an electrical power conducting circuit between the power supply and the laser module in a power ON mode, and for opening an electrical power conducting circuit between the power supply and the laser module in a power OFF mode;
an actuator coupled to the control switch for selectively operating the control switch in the power ON mode or in the power OFF mode in response to movement of the actuator relative to the control switch; and
a stylus mounted on the housing for movement relative to the control switch, the stylus including a first end portion mechanically coupled to the control switch actuator and a second end portion projecting outside of the housing.

2. An optical pointer according to claim 1, wherein the stylus is movable to a first position in which the second end portion of the stylus is retracted relative to the control switch and the actuator sets the control switch for operation in the power ON mode, and the stylus being movable to a second position in which the second end portion of the stylus is extended relative to the control switch and the actuator sets the control switch for operation in the power OFF mode.

3. An optical pointer according to claim 1, wherein the stylus is extendable and retractable relative to the control switch along an axis that is substantially parallel to the laser beam projection axis.

4. An optical pointer according to claim 1, wherein the control switch is a single pole, single throw switch characterized by momentary ON operation.

5. An optical pointer according to claim 1, wherein the control switch is a single pole, single throw switch characterized by momentary ON operation, and the actuator is a push button that is mechanically coupled to the first end portion of the stylus.

6. An optical pointer according to claim 1, wherein:
the laser light generator comprises a laser diode and a laser diode driver circuit; and
the laser diode driver circuit comprises a power input terminal connected in series circuit relation with the control switch and a power output terminal connected in series circuit relation with the laser diode.

7. An optical pointer according to claim 1, wherein:
the laser light generator comprises a semiconductor laser diode and a laser diode driver circuit;
the driver circuit comprises a power input terminal connected in series circuit relation with the control switch, a power output terminal connected in series circuit relation with the laser diode, and a modulator input terminal; and
the optical pointer further including:
a modulation signal circuit for generating a laser diode modulation signal, the modulation signal circuit including a power input terminal connected to receive operating power through the control switch and a modulation signal output terminal connected to the modulation input terminal of the driver circuit.

8. An optical pointer according to claim 7, wherein the modulation circuit is capable of generating an analog output signal that induces pulse repetition modulation of the optical beam.

9. An optical pointer according to claim 7, wherein the modulation circuit is capable of generating an analog output signal that induces amplitude modulation of the optical beam intensity.

10. An optical pointer according to claim 1, wherein the laser light generator comprises a semiconductor diode capable of projecting a control cursor in the form of a monochromatic laser beam.

11. An optical pointer according to claim 1, wherein the power supply comprises a plurality of conductive interconnect terminals for engaging a DC voltage source.

12. An optical pointer according to claim 1, wherein the power supply comprises a dry cell battery.

13. An optical pointer according to claim 1, further comprising:
a first push button switch disposed in the housing and electrically coupled to the power supply and to the laser module for closing an electrical power conducting circuit between the power supply and the laser module in a power ON mode, and for opening an electrical power conducting circuit between the power supply and the laser module in a power OFF mode; and
wherein the first push button switch is a single pole, single throw switch characterized by momentary ON operation, and including a push button actuator projecting outside of the housing allowing actuation of the first push button switch by finger manipulation.

14. An optical pointer according to claim 1, further comprising:
a second push button switch disposed in the housing and electrically coupled to the power supply and to the laser module for closing an electrical power conducting circuit between the power supply and the laser module in a power ON mode, and for opening an electrical power conducting circuit between the power supply and the laser module in a power OFF mode;
wherein the second push button switch is a single pole, single throw switch characterized by momentary ON operation, and including a push button actuator projecting outside of the housing allowing actuation of the second push button switch by finger manipulation;
the laser light generator comprises a semiconductor laser diode and a laser diode driver circuit;
the driver circuit comprises a power input terminal connected in series circuit relation with the second push button switch, a power output terminal connected in series circuit relation with the laser diode, and a modulator input terminal; and
a modulation signal circuit for generating a laser diode modulation signal, the modulation circuit including a power input terminal connected to receive operating power through the second push button switch and a signal output terminal connected to the modulation input terminal of the driver circuit.

15. In an optical pointer of the type including a laser light generator for projecting a laser beam onto a display screen and an electrical power supply for applying operating power to the laser light generator, the improvement comprising:
a control switch electrically coupled to the power supply and to the laser light generator for opening and closing an electrical power conducting circuit between the power supply and the laser light generator;
an actuator coupled to the control switch for selectively turning the switch ON and OFF in response to movement of the actuator relative to the control switch; and
a stylus including a first end portion coupled to the actuator for moving the actuator relative to the control switch, and a second end portion projecting outside of the pointer.

16. In an optical pointer of the type including a laser light generator for projecting a laser beam onto a display screen and an electrical power supply for applying operating power to the laser light generator, the improvement comprising:
first control circuitry including a first manually operable push button switch for selectively initiating powered operation of the optical pointer in a position-dependent, control cursor spot projection mode that enables remote initiation of computer keyboard commands and/or pointing device position-dependent cursor operations;
second control circuitry including a second manually operable push button switch for selectively initiating powered operation of the optical pointer in a remote presentation function selection mode in which predetermined spatial image patterns can be projected onto a presentation screen by gesturing the pointer; and
third control circuitry including a third push button switch and a stylus actuator coupled to said switch for selectively initiating powered operation of the optical pointer in a close proximity scribe mode in which optical images can be manually annotated or drawn on the presentation screen by stylus actuation of said control switch to the ON power conducting condition by manually pushing or drawing the stylus against the display screen.

17. An optical pointer for projecting a laser beam onto a presentation screen of an optical projection system, the optical pointer comprising:
a housing having a handle portion and a beam projection end portion attached to the handle portion;
a laser module disposed in the housing, the laser module including a laser light generator for projecting a beam of laser light along an axis passing through an aperture formed in the beam projection end portion;
a control switch electrically coupled to the power supply and to the laser light generator for opening and closing an electrical power conducting circuit between the power supply and the laser light generator;
an actuator coupled to the control switch for selectively turning the switch ON and OFF in response to movement of the actuator relative to the control switch; and
a stylus including a first end portion coupled to the actuator for moving the actuator relative to the control switch, and a second end portion projecting through an aperture formed in the beam projection end portion of the housing for engaging the surface of a display screen.

18. An optical pointer according to claim 17, wherein the stylus is disposed for extension and retraction relative to the control switch along an axis that is extends substantially in parallel with and radially offset from the laser beam projection axis.

19. In an optical pointer of the type including a laser light generator for projecting a laser beam, a power supply for supplying electrical operating power to the laser light generator and a push button switch electrically coupled to the power supply and to the laser light generator for selectively applying operating power to the laser light generator, the improvement comprising:
a control switch electrically coupled to the power supply and to the laser light generator for applying operating power to the laser light generator;
an actuator coupled to the control switch for selectively turning the control switch ON and OFF in response to movement of the actuator relative to the control switch; and
a stylus including a first end portion coupled to the actuator for moving the actuator relative to the control switch and a second end portion projecting outside of the pointer for engaging the surface of a presentation screen.

20. An optical pointer for projecting a laser beam onto a presentation screen of an optical projection system, the optical pointer comprising:
a housing;
an electrical power supply disposed in the housing;
a laser module disposed in the housing, the laser module including a laser light generator for projecting a beam of laser light along an axis;
a control switch electrically coupled to the power supply and to the laser module for closing an electrical power conducting circuit between the power supply and the laser module in a power ON mode, and for opening an electrical power conducting circuit between the power supply and the laser module in a power OFF mode;
an actuator coupled to the control switch for selectively operating the control switch in the power ON mode or in the power OFF mode in response to movement of the actuator relative to the control switch;
a stylus disposed in the housing for movement relative to the control switch, the stylus including a first end portion mechanically coupled to the actuator and a second end portion projecting out of the housing;
a first push button switch disposed in the housing and electrically coupled to the power supply and to the laser module for closing an electrical power conducting circuit between the power supply and the laser module in a power ON mode, and for opening an electrical power conducting circuit between the power supply and the laser module in a power OFF mode;
wherein the first push button switch is a single pole, single throw switch characterized by momentary ON operation, and including a push button actuator projecting out of the housing for actuating the first push button switch by finger manipulation;
a second push button switch disposed in the housing and electrically coupled to the power supply and to the laser module for closing an electrical power conducting circuit between the power supply and the laser module in a power ON mode, and for opening an electrical power conducting circuit between the power supply and the laser module in a power OFF mode;
wherein the second push button switch is a single pole, single throw switch characterized by momentary ON operation, and including a push button actuator projecting out of the housing for actuating the second push button switch by finger manipulation; and
a modulation circuit for generating a laser diode modulation signal, the modulation circuit including a power input terminal connected to receive operating power through the second push button switch and a signal output terminal connected to the laser light generator.
